(19) United States
(12) Patent Application Publication
(10) Pub. No.: US 2009/0158037 A1
(43) Pub. Date: Jun. 18, 2009

(54) SYSTEM AND METHOD FOR PROTECTING AN ELECTRONIC FILE

(75) Inventors: CHUNG-I LEE, Tu-Cheng (TW); HAI-HONG LIN, Shenzhen City (CN); DE-YI XIE, Shenzhen City (CN); CHEN-CHEN ZHANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen (CN); HON HAI PRECISION INDUSTRY CO., LTD., Tu-Cheng (TW)

(21) Appl. No.: 12/325,277

(22) Filed: Dec. 1, 2008

(30) Foreign Application Priority Data
Dec. 14, 2007 (CN) 200710203063.7

(51) Int. Cl. H04L 9/00; H04L 9/08

(52) U.S. Cl. 713/165

(57) ABSTRACT

A method for protecting an electronic file is provided. The method symmetrically encrypts the electronic file with a symmetric key, and asymmetrically encrypts the symmetric key. In addition, the method calculates a message digest for the encrypted electronic file, and obtains a trusted timestamp for the message digest. The method may provide security and authenticity for the electronic file.

### FIELD OF THE INVENTION

Embodiments of the present disclosure relate to a system and method for information security, and more particularly to a system and method for protecting an electronic file.

### DESCRIPTION OF RELATED ART

Due to the growth of various sensitive information stored in computers or transmitted over networks, the need for ensuring the privacy of information has risen multifold. For example, there may be electronic documents in computers that are strictly confidential. In another example, a lot of personal and private information transmit over the Internet such as credit card information, social security numbers, personal details, bank information, etc. Therefore, it has become essential that the information should be secured. In addition, for some information, such as business secrets, authenticity of the information is required to be provided.

What is needed, therefore, is a method for automatically protecting an electronic file so as to achieve data security and authenticity.

### BRIEF DESCRIPTION OF THE DRAWINGS

FIG. 1 is a block diagram of one embodiment of a system for protecting an electronic file;

FIG. 2 is a block diagram of one embodiment of a protection system comprising function modules; and

FIG. 3 is a flowchart of one embodiment of a method for protecting an electronic file.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

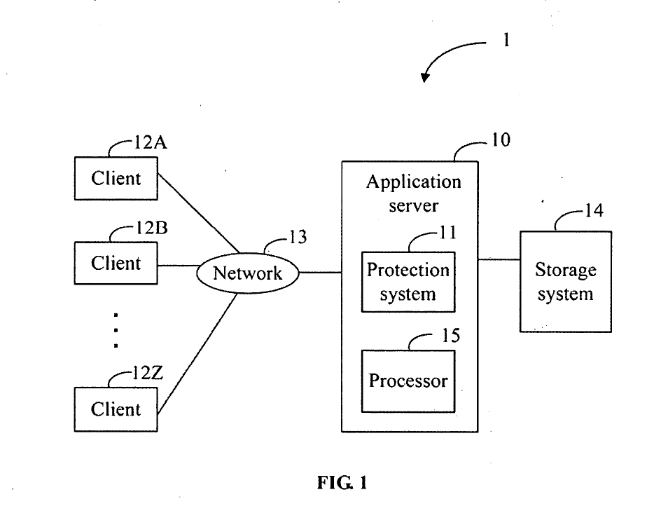

FIG. 1 is a block diagram of one embodiment of a system 1 for protecting an electronic file. The system 1 may be used to achieve security and authenticity for the electronic file. In one embodiment, the system 1 comprises an application server 10, clients 12A-12Z, and a storage system 14. The application server 10 is connected to the clients 12A-12Z over a network 13. The network 13 may be the Internet, an intranet, or any other suitable communication network. The application server 10 is further connected to the storage system 14 storing various relevant data, such as original electronic files, and encrypted electronic files.

The application server 10 includes a protection system 11. The protection system 11 is configured for encrypting an electronic file, and storing the encrypted electronic file into the storage system 14. The protection system 11 is further configured for obtaining a trusted timestamp (or timemark) from a trusted third party (TTP). It may be understood that a trusted timestamp is issued by a trusted third party acting as a timestamping authority (TSA). In the present disclosure, the trusted timestamp is used to prove the existence of the electronic file before the trusted timestamp is issued. It may be further understood that the application server 10 may comprise one or more processors, such a processor 15 to execute the protection system 11.

Each of the clients 12A-12Z provides a user interface to process electronic files, such as creating an electronic file, modifying an electronic file, and/or viewing an electronic file. In one embodiment, digital signatures of the users, such as creator, modifiers, and views are inserted into the electronic files in order to acknowledge the electronic files.

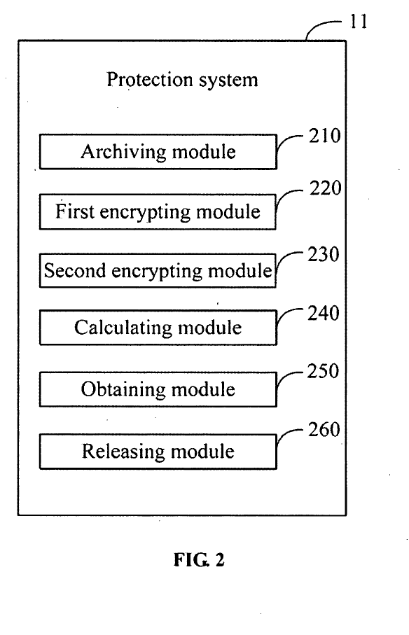

FIG. 2 is a block diagram of one embodiment of the protection system 11 comprising function modules. In one embodiment, the protection system 11 may include an archiving module 210, a first encrypting module 220, a second encrypting module 230, a calculating module 240, an obtaining module 250, and a releasing module 260. One or more specialized or general purpose processors, such as the processor 15 may be used to execute the archiving module 210, the first encrypting module 220, the second encrypting module 230, the calculating module 240, the obtaining module 250, and the releasing module 260.

The archiving module 210 is configured for archiving a plurality of electronic files into an electronic file archive, and deleting the plurality of electronic files from the storage system 14. As such, the electronic files can be protected as a whole, especially the electronic files relating to one subject.

The first encrypting module 220 is configured for symmetrically encrypting the electronic file archive with a symmetric key, and storing the encrypted electronic file archive into the storage system 14. It may be understood that a symmetric encryption encrypts or decrypts data using a symmetric key.

The second encrypting module 230 is configured for encrypting the symmetric key to strengthen security of the electronic files, and storing the encrypted symmetric key into the storage system 14. In one embodiment, the second encrypting module 230 asymmetrically encrypts the symmetric key with an asymmetric encryption key (or public key), and encrypts a corresponding asymmetric decryption key (or private key). The second encrypting module 230 stores the encrypted symmetric key and the encrypted asymmetric decryption key into the storage system 14. It may be understood that asymmetric cryptography consists of a pair of keys known as an asymmetric encryption key and an asymmetric decryption key. It is impossible to ascertain a corresponding asymmetric decryption key with the help of an asymmetric encryption key.

The calculating module 240 is configured for calculating a message digest for the encrypted electronic file archive by using a hash function. It may be understood that a hash, such as a message digest, is a sort of digital fingerprint of original data. If the original data are changed, then a completely different hash is derived. In addition, the hash function is a kind of one-way function. Therefore, the encrypted electronic file archive cannot be calculated from the message digest.

The obtaining module 250 is configured for obtaining a trusted timestamp for the message digest from a trusted third party. As mentioned above, the trusted timestamp may prove the existence of the electronic file before the trusted timestamp is issued. By this means, authenticity of the digital message is achieved.

The releasing module 260 is configured for releasing the message digest and the timestamp to the public, such as on the Internet, so as to enable the public to verify authenticity of the electronic files.

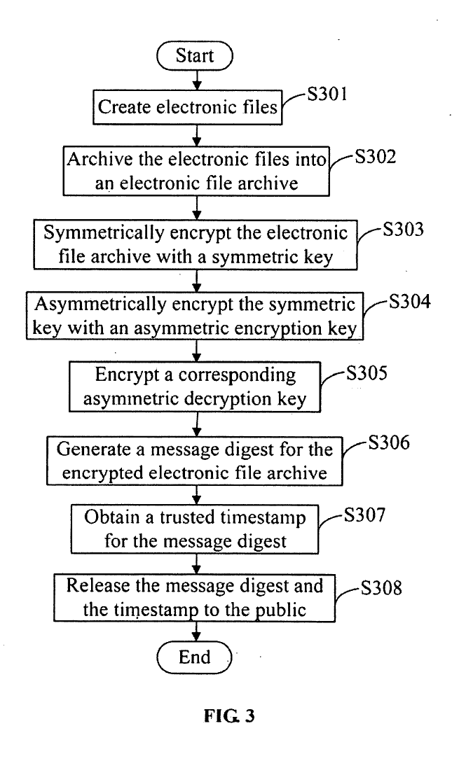

FIG. 3 is a flowchart of one embodiment of a method for protecting an electronic file by implementing the system of FIG. 1. The method may be used to achieve security and authenticity for the electronic file. Depending on the embodiments, additional blocks may be added, others removed, and the ordering of the blocks may be changed.

In block 301, a plurality of electronic files are created on the clients 12A-12Z. In one embodiment, digital signatures of users that process the plurality of electronic files, such as creators, modifiers, viewers are inserted into the plurality of electronic files to acknowledge the electronic files.

In block 302, the archiving module 210 archives the plurality of electronic files into an electronic file archive to protect the electronic files as a whole, and deletes the plurality of electronic files from the storage system 14. For example, the plurality of electronic files is archived into an electronic file archive in a format of “*.tar.” In one embodiment, the archiving module 210 further compresses the electronic file archive into a compressed electronic file archive so as to save storage space. For example, the electronic file archive is compressed into a compressed electronic file archive in a format of “*.zip,” or “*rar.”

In block 303, the first encrypting module 220 symmetrically encrypts the electronic file archive with a symmetric key, and stores the encrypted electronic file archive into the storage system 14. In one embodiment, the first encrypting module 220 symmetrically encrypts the electronic file archive by using a data encryption standard (DES) encryption algorithm. Depending on the embodiment, other encryption algorithms, such as an RC4 encryption algorithm, a Blowfish encryption algorithm, or an advanced encryption standard (AES) encryption algorithm may be used to symmetrically encrypts the electronic file archives

In block 304, the second encrypting module 230 asymmetrically encrypts the symmetric key with an asymmetric encryption key, and stores the encrypted symmetric key into the storage system 14. In one embodiment, the second encrypting module 230 asymmetrically encrypts the symmetric key by using a RSA encryption algorithm. Depending on the embodiment, other encryption algorithms, such as an El Gamal encryption algorithm may be used to symmetrically encrypt the electronic file.

In block 305, the second encrypting module 230 encrypts an asymmetric decryption key corresponding to the asymmetric encryption key, and stores the encrypted asymmetric decryption key into the storage system 14. In one embodiment, the second encrypting module 230 encrypts the asymmetric decryption key by using a password based encryption (PBE) algorithm.

In block 306, the calculating module 240 calculates a message digest for the encrypted electronic file archive by using a hash function. In one embodiment, the calculating module 240 calculates a message digest by using a SHA hash function. Depending on the embodiment, other hash functions, such as a MD5 hash function may be used to calculate the message digest.

In block 307, the obtaining module 250 obtains a trusted timestamp for the message digest from a trusted third party so as to achieve authenticity of the electronic file. In block 308, the releasing module 260 releases the message digest and the timestamp to the public, such as on the Internet, so as to enable the public to verify authenticity of the electronic files.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for protecting an electronic file, the system comprising:
a first encrypting module configured for symmetrically encrypting the electronic file with a symmetric key, and storing the encrypted electronic file into a storage system;
a second encrypting module configured for encrypting the symmetric key, and storing the encrypted symmetric key into the storage system;
a calculating module configured for calculating a message digest for the encrypted electronic file by using a hash function;
an obtaining module configured for obtaining a trusted timestamp for the message digest from a trusted third party so as to achieve authenticity of the electronic file; and
at least one processor for executing the first encrypting module, the second encrypting module, the calculating module, and the obtaining module.

2. The system of claim 1, further comprising an archiving module configured for archiving a plurality of electronic files into an electronic file archive.

3. The system of claim 1, further comprising a releasing module configured for releasing the message digest and the timestamp to the public.

4. The system of claim 1, wherein the first encrypting module symmetrically encrypts the electronic file by using a data encryption standard (DES) encryption algorithm.

5. The system of claim 1, wherein the second encrypting module asymmetrically encrypts the symmetric key with an asymmetric encryption key, and encrypts an asymmetric decryption key corresponding to the asymmetric encryption key.

6. The system of claim 5, wherein the second encrypting module asymmetrically encrypts the symmetric key by using a RSA encryption algorithm.

7. A computer-implemented method for protecting an electronic file, the method comprising:
(a) symmetrically encrypting the electronic file with a symmetric key, and storing the encrypted electronic file into a storage system;
(b) encrypting the symmetric key, and storing the encrypted symmetric key into the storage system;
(c) calculating a message digest for the encrypted electronic file by using a hash function; and
(d) obtaining a trusted timestamp for the message digest from a trusted third party so as to achieve authenticity of the electronic file.

8. The method of claim 7, further comprising:
archiving a plurality of electronic files into an electronic file archives

9. The method of claim 7, further comprising:
releasing the message digest and the timestamp to the public.

10. The method of claim 7, wherein the electronic file is symmetrically encrypted according to a data encryption standard (DES) encryption algorithm.

11. The method of claim 7, wherein the symmetric key is asymmetrically encrypted with an asymmetric encryption key, and an asymmetric decryption key corresponding to the asymmetric encryption key is encrypted.

12. The method of claim 11, wherein the symmetric key is asymmetrically encrypted according to a RSA encryption algorithm.

13. A computer-readable medium having stored thereon instructions that, when executed by a computerized device, cause the computerized device to:
symmetrically encrypt an electronic file with a symmetric key, and storing the encrypted electronic file into a storage system;
encrypt the symmetric key, and storing the encrypted symmetric key into the storage system;
calculate a message digest for the encrypted electronic file by using a hash function; and
obtain a trusted timestamp for the message digest from a trusted third party so as to achieve authenticity of the electronic file.

14. The medium of claim 13, wherein the instructions further cause the computerized device to archive a plurality of electronic files into an electronic file archive.

15. The medium of claim 13, wherein the instructions further cause the computerized device to release the message digest and the timestamp to the public.

16. The medium of claim 13, wherein the electronic file is symmetrically encrypted according to a data encryption standard (DES) encryption algorithm.

17. The medium of claim 13, wherein the symmetric key is asymmetrically encrypted with an asymmetric encryption key, and an asymmetric decryption key corresponding to the asymmetric encryption key is encrypted.

18. The medium of claim 17, wherein the symmetric key is asymmetrically encrypted according to a RSA encryption algorithm.
